(19) United States
(12) Patent Application Publication
(10) Pub. No.: US 2024/0281801 A1
(43) Pub. Date: Aug. 22, 2024

(54) SECURE LEDGER REGISTRATION

(71) Applicant: Hewlett-Packard Development Company, L.P., Spring, TX (US)

(72) Inventors: YELENA HELEN BALINSKY, BRISTOL (GB); JOSEP ABAD PEIRO, SANT CUGAT DEL VALLES (ES)

(73) Assignee: Hewlett-Packard Development Company, L.P., Spring, TX (US)

(21) Appl. No.: 18/292,206

(22) PCT Filed: Aug. 26, 2021
(86) PCT No.: PCT/US2021/071288

§ 371 Date: Jan. 25, 2024

(51) Int. Cl. G06Q 20/38

(52) U.S. Cl. CPC G06Q 20/38215

(57) ABSTRACT

A non-transitory computer readable medium is provided. The computer readable medium is encoded with instructions which when executed by a processor, cause the processor to receive a certificate of authentication from an authentication entity, the certificate of authentication certifying that a user has been authenticated by the authentication entity, verify the certificate of authentication, receive a cryptographic key associated to the user, generate a secure ledger transaction request, the transaction request comprising the cryptographic key, identification data associated to the user and the certificate of authentication and communicate the transaction request to the secure ledger.

### BACKGROUND

Secure ledger and blockchain technology is now being implemented across a diverse range of applications. A secure ledger may, for example, provide guarantees that certain transactions have taken place between two or more parties or that a logical process has been followed according to a contract. A secure ledger may be implemented by a blockchain service provider. A user interacts with the blockchain service provider via a client program installed on their device. Transaction requests may be submitted by parties to the secure ledger. Entries in the secure ledger are formed from data generated from previous entries and recent transactions. Transaction requests are digitally signed by the party and the digital signature is automatically verified when the transaction request is received by the blockchain service. The resulting ledger provides an immutable secure record of transactions that have taken place between different parties.

### BRIEF DESCRIPTION OF THE DRAWINGS

FIG. 1 is a schematic diagram showing an apparatus, according to an example.

FIG. 2 is a flow diagram showing a protocol for authorizing access to a secure ledger, according to an example.

FIG. 3 is a block diagram showing a method for authorizing a user to access a secure ledger, according to an example.

FIG. 4 is a schematic diagram showing a processor and memory, according to an example.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

Secure ledgers or ‘blockchains’ comprise a secure digital verifiable record of transactions between entities. Secure ledgers comprise a plurality of blocks that are generated sequentially to form a chain. Secure ledgers are secure-by-design in that each block depends on the previous blocks in the chain. The integrity of any point of the ledger can be verified by recomputing hash values on inputs and checking the recomputed hash values against the ledger. This prevents a party maliciously modifying records without the modification being detected by another party. Furthermore, each block in the secure ledger comprises a digital signature that provides assurance about the origin, integrity and authenticity of the transactions represented in the block.

Secure ledgers may be stored in a decentralized fashion across multiple nodes. For example, the ledger may be stored across a peer-to-peer network where nodes hold their own copy of the ledger. In that case, the verification of a transaction may occur by recomputing values at nodes and reaching a consensus. In other cases, a blockchain service may be centralised within a company or organisation, for example. These private or ‘permissioned’ blockchains may implement an access control layer to govern access to the underlying network. Validators on private blockchain networks may be vetted by an administration service. Validation of transactions in private blockchains may be executed by an authorizing party that operates within the overall blockchain service.

According to examples, when a user wishes to access an organisation's private blockchain service, the user first registers a public key from a cryptographic public/private key pair. The private key is kept confidential. In examples, the registration of the user may be enacted via the creation of a ledger record in the secure ledger. The record may contain the user's public key and additional metadata such as the role of the user in the organisation.

The record can be certified by a blockchain service administrator, an automatic enrollment service or another administrator service, depending on the structure of an organization. Each of these parties is, in turn, also a blockchain client, whose public key has been certified by the same registration process as a user by an entity with a higher privilege access.

On the one hand this federated or cascaded enrollment process provides robustness and resilience since there are multiple accountable entities operating at different levels of privilege within an organization. On the other hand, this may be abused by unscrupulous or compromised entities. A part with a higher level of access than another entity may register a fake identity for that entity without their consent or awareness by generating a public/private key pair and registering it with the blockchain service in the other entities' name. For example, to impersonate an existing employee in an organization, an administrator may create a binding of a public key to an existing employee identify such as an email address or other employee identifier.

The methods and systems described herein provide secure user enrollment for cascaded and federated blockchains. In particular the methods described herein prevent a user identity being created by entities within an organization such as administrators and service providers illegitimately. The methods described herein protect users from potential impersonation attacks where a compromised administrator creates a fake identity for the user. Furthermore, the methods described herein also protect the blockchain service from non-repudiation by an entity: a user may not falsely deny that a recorded transaction was created using a bogus identity.

The methods described utilize a specially formed blockchain transaction together with a corresponding smart contract, programmed to validate such transaction record. Following successful authentication of a user the authorizing party creates a transaction request. The transaction request binds the user's organizational identity such as their email address employee identifier, or distinguished name with the user's public key. The transaction request is signed with the digital signature of the authorizing party. Once this transaction request is validated and included into a corresponding secure ledger, the user becomes a registered secure ledger user. In examples a registered user may interact with blockchain services according to an assigned role within the organization.

The methods described herein address the security of enrollment of users by introducing verifiable information, which is present in the payload of the user registration transaction. According to examples, this information may not be generated without an active use of valid user credentials and with active user participation with another organization service.

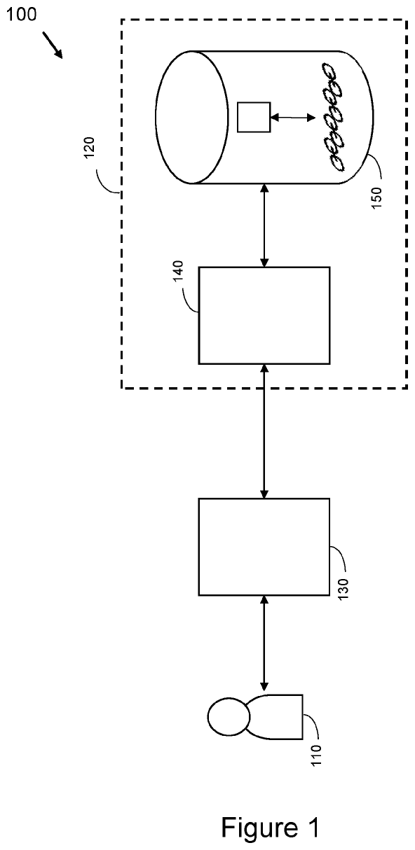

FIG. 1 is a simplified schematic diagram 100 showing an apparatus according to an example. The apparatus shown in FIG. 1 may be used in conjunction with the other methods and systems described herein. In FIG. 1 a user 110 wishes to enrol with a blockchain service 120. The blockchain service 120 may be associated with an organisation. According to examples, the user 110 may be an employee within the organization. For example, the user 110 may be a new employee who is to be enrolled with the blockchain service 120 or an existing user within the organisation.

In FIG. 1 the user 110 may have a personal device such as a laptop or smartphone to connect with other entities. In other examples the user 110 may have access to a computer, such as a desktop computer or remote desktop, that is controlled by the organisation itself. The user's device may provide wired and/or wireless communication capabilities that allow the user 110 to connect with remote entities via a network.

In examples described herein the user 110 connects with an authentication entity 130. The authentication entity 130 may comprise physical devices, software, other hardware, interfaces and any combination of these. In examples, the authentication entity 130 may provide authentication services for an organisation. For example, the authentication entity 130 may be a web-based interface or portal which the user 110 is initially redirected to upon accessing an organisations local network.

According to examples described herein the authentication entity 130 may prompt the user 110 to sign in using a login credential such as a user name and password. In another case, the authentication entity 130 may prompt the user 110 to insert a smart card into a smart card reader. In some cases, the authentication entity 130 may ask the user 110 to provide a form of photographic id, biometric data or other form of identification information. In some cases the authentication entity 130 may prompt the user to enter text data indicating a purpose for the authentication. The user 110 may enter text data specifying that they wish to enrol with the blockchain service 120.

In the example shown in FIG. 1 the blockchain service 120 comprises a blockchain authorizing entity 140. The blockchain authorizing entity 140 may communicate with the user 110 and authentication entity 130 across a network. The blockchain service 120 comprises a secure ledger 150. According to examples the secure ledger 150 may be implemented as a blockchain or a hash chain. Data that is stored in the secure ledger 150 is determined on the basis of previous data written to the ledger and further input data received from the user 110, authentication entity 130 and/or blockchain authorizing entity 140. Subsequent ledger entries may be computed using, for example, a secure cryptographic hash function. This creates a secure-by-design, immutable record of ledger entries.

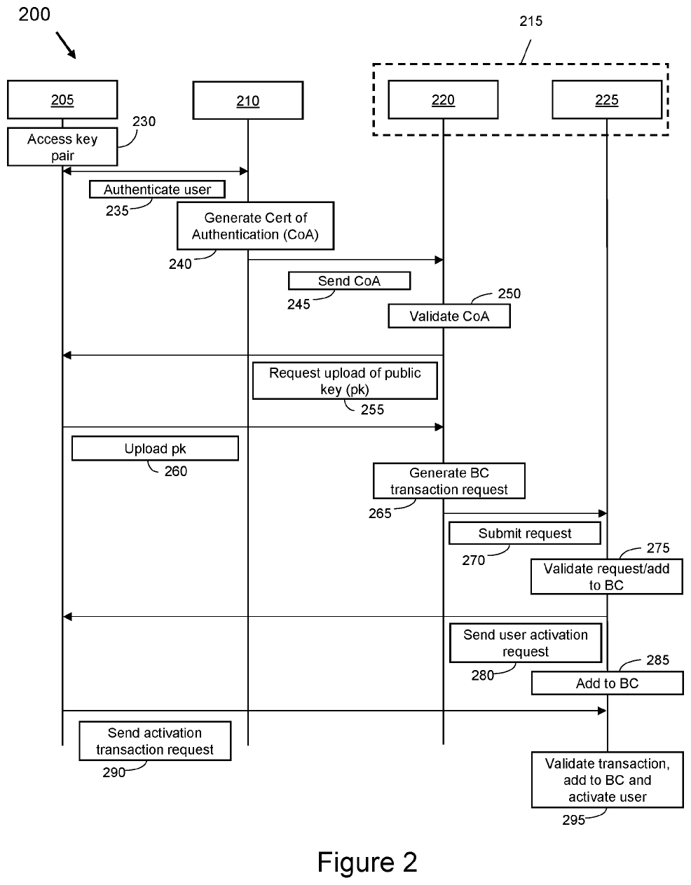

FIG. 2 is a simplified schematic diagram showing a protocol 200 for enrolling a user with a blockchain service. The protocol 200 shown in FIG. 2 may be implemented on the apparatus 100 shown in FIG. 1. In particular, the protocol 200 may be implemented between the user 110, blockchain service 120 and authentication entity 130 shown in FIG. 1.

In FIG. 2, block 205 represents a user device that may be operated by a user such as user 110 shown in FIG. 1. The block 210 may be the authentication entity 130 shown in FIG. 1. The block 215 may be the blockchain service 120 comprising a blockchain authorizing entity 220 secure ledger 225.

At block 230, the user device 205 accesses a public/private cryptographic key pair. For example, the user device 205 may generate a public/private key pair and access the key pair from memory. Alternatively, the user device 205 may access a previously generated key pair or receive a key pair from another entity. The user may then navigate to, for example, a blockchain enrolment service on their device. This service may be provided by the authentication entity 210. According to examples, at block 235 the user device 205 is authenticated by the authentication entity 210. This may comprise the user being prompted to sign in, using login credentials, a smartcard, a pin, and/or an identification. The user may further explicitly type on the device 205 or otherwise confirm the explicit purpose for the authentication with the authentication entity 210.

In examples described herein, following successful authentication of the user, the authentication entity 210 generates, at block 240, a certificate of authentication (CoA) that confirms the successful authentication of the user with an intent to enroll with the blockchain service 215. The CoA may be a cryptographically secure certificate that is generated by digitally signing the record of the interaction with the user device 205.

According to examples, the CoA may comprise the user's organization identifier such as an email address, employee number, Lightweight Directory Access Protocol (LDAP) Distinguished Name or other unique identifier. The CoA may further comprise data indicative of the purpose of the CoA attesting the successful authentication of the user for enrollment into the blockchain service 215. In some examples, the CoA may comprise a time stamp and/or a time period in which the certificate remains valid.

At block 245 the CoA is communicated by the authentication entity 210 to the blockchain authorizing entity 220. Upon receiving the CoA, at block 250, the blockchain authorizing entity 220 validates the CoA. In examples, validating the CoA may comprise determining the validity of the signature and time stamp. At block 255 the blockchain authorizing entity 220 prompts the user 205 to upload the public key component of the previously accessed public/private key pair of the user device 205. In an alternative example, the user may be prompted to upload their public key during the authentication session with the authentication entity 210. According to examples, the public key of the user may be included in the CoA.

At block 265, once the user's public key is uploaded, to the blockchain authorizing entity 220, the blockchain authorizing entity 220 generates a first transaction request. In examples described herein the transaction request may comprise the user's identification information, the CoA, the user's public key, and/or a timestamp which is within the validity period of the CoA. The transaction request is signed by the blockchain authorizing entity using their private signing key. At block 270 the request is submitted to the secure ledger 225.

At block 275 the secure ledger 225 validates the transaction request and records the transaction in the secure ledger 225. According to examples, the secure ledger 225 may execute a smart contract, to execute logic that performs the validation process. In particular, the secure ledger 225 may validate signatures of both the authentication entity 210 for the CoA and the transaction request received from the blockchain authorizing entity 220. The secure ledger 225 may determine whether the timestamps are within acceptable ranges as permitted by the smart contract logic and validity period of the CoA. In examples, the secure ledger 225 may determine whether the user was previously registered with the blockchain service 215. In the event the user has previously been registered, the transaction request may be rejected on the grounds that an entity is attempting to register a fake user identity.

Once these actions have been performed, and the transaction is successfully validated, the transaction is recorded in the secure ledger 225. According to examples, generating a new entry to the secure ledger comprises computing a hash value by evaluating a hash function on the basis of the payload and previous entries on the secure ledger.

In FIG. 2, when the new transaction request has been added to the secure ledger 225, the blockchain service 215 may communicate with the user 205 to confirm registration. According to examples, the user device may not be activated to access the secure ledger 225 until the user has proactively engaged with the blockchain service 215. In examples described herein the blockchain service may communicate a user activation request at block 280. In some cases a user activation request may comprise sending an invite email or text message to the user to confirm registration. A user activation request may also comprise a unique random number. The secure ledger 225 may create a second transaction record confirming that the user activation request has been sent to the user 205.

At block 290 the user communicates a transaction request to the secure ledger. The transaction request may comprise the unique random number and a signature generated by the user using their private key. At block 295 the secure ledger smart contract validates the transaction request. According to examples, validating the request comprises validating the signature using the public key of the user 205. In examples validating the transaction request may comprise determining whether the unique random number in the transaction request matches the unique random number of the previous transaction recorded to the secure ledger 225. Once this transaction is validated the user 205 becomes authorized with the blockchain service 215. The user's public key may also be read by other entities who are authorized to access the blockchain service 215.

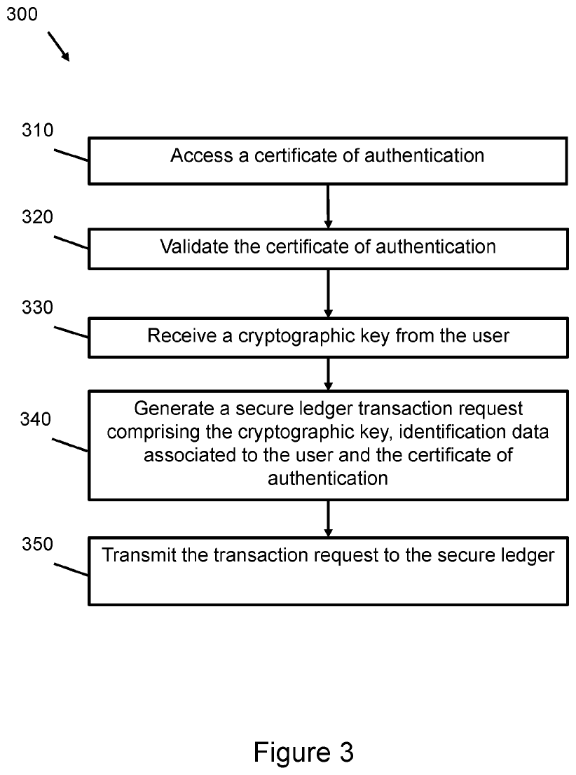

FIG. 3 is a block diagram showing a method 300 method for authorizing a user to access a secure ledger. The method 300 may be used in conjunction with the apparatus, methods and examples described herein. In particular, the method 300 may be implemented by the blockchain service 120 shown in FIG. 1.

At block 310, the method 300 comprises accessing a certificate of authentication. In examples the certificate of authentication attests that the user is authenticated. That is, the certificate of authentication provides a verifiable record that the user has been authenticated by e.g. the authentication entity 130 shown in FIG. 1.

The certificate of authentication may comprise identification data associated to the user, data comprising a request to authorize the user to access the secure ledger a cryptographically secure signature associated to the authentication entity and data comprising a time stamp and/or a time period in which the certificate of authentication is valid. According to examples, the certificate may be accessed from a storage device or memory that stores data received from an entity such as the authentication entity 130 shown in FIG. 1.

At block 320, the method 300 comprises validating the certificate of authentication. According to examples, validating a certificate of authentication comprises verifying that the certificate was validly signed by e.g. the authentication entity 130 using it's private key. According to examples, validating a certificate of authentication may comprise verifying a timestamp and/or verifying that the certificate is still within a time period of validity in which the certificate remains valid.

At block 330, the method 300 comprises receiving a cryptographic key from the user. According to examples, the cryptographic key is a public key from public/private key pair generated by the user. According to examples, a cryptographic key may be received from the user via the certificate of authentication. In other words, a user may supply an authentication entity with a valid key, and the authentication entity may supply the entity implementing the method 300 with the key at the same time as the certificate of authentication. In other cases, a user may supply the public key directly.

At block 340, the method comprises generating a secure ledger transaction request comprising the cryptographic key, identification data associated to the user and the certificate of authentication. Generating a secure ledger transaction request may comprise generating a cryptographic signature using a signing key to authenticate the transaction. At block 350, the method comprises transmitting the transaction request to the secure ledger.

According to examples, the method 300 may comprise receiving a first secure ledger transaction request, verifying the first transaction request and generating a secure ledger entry on the basis of the verification. Generating a secure ledger entry may comprise computing an output of a cryptographic hash function. For example, the secure ledger entry may be determined on the basis of the previous entry in the secure ledger and a further input. The further input may comprise data associated to the first transaction request.

According to examples, the method 300 may comprise transmitting a user activation request to the user, generating a second secure ledger entry comprising data indicating that the user activation request has been transmitted to the user, receiving a second secure ledger transaction request in response to the user activation request, verifying the second transaction request and generating a third secure ledger entry based on the second transaction request, the third secure ledger entry indicating that the user is authorized to access the secure ledger. According to examples, the user activation request may comprise a unique number. In that case, verifying the second transaction request may comprise determining whether the unique number is included in the second transaction request.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing apparatus may execute the machine-readable instructions. Thus, modules of apparatus may be implemented by a processor executing machine-readable instructions stored in a memory, or a processor operating in accordance with instructions embedded in logic circuitry. The term ‘processor’ is to be interpreted broadly to include a CPU, processing unit, ASIC, logic unit, or programmable gate set etc. The methods and modules may all be performed by a single processor or divided amongst several processors.

Such machine-readable instructions may also be stored in a computer readable storage that can guide the computer or other programmable data processing devices to operate in a specific mode.

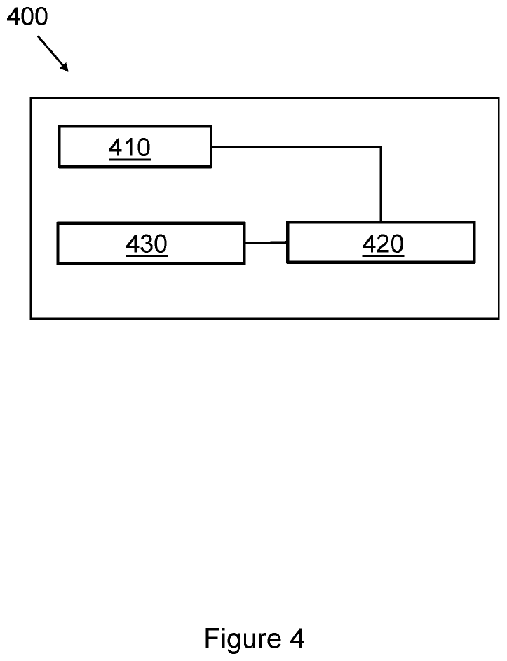

For example, the instructions may be provided on a non-transitory computer readable storage medium encoded with instructions, executable by a processor. FIG. 4 shows an example of a processor 410 associated with a memory 420. The memory 420 comprises computer readable instructions 430 which are executable by the processor 410.

The instructions 430 cause the processor to receive a certificate of authentication from an authentication entity, the certificate of authentication certifying that a user has been authenticated by the authentication entity. The instructions further cause the processor to: verify the certificate of authentication, receive a cryptographic key associated to the user, generate a secure ledger transaction request, the transaction request comprising the cryptographic key, identification data associated to the user and the certificate of authentication and communicate the transaction request to the secure ledger.

According to a second example, the instructions 430 cause the processor 410 to receive a first secure ledger transaction request, the first transaction request comprising a cryptographic key associated to a user, identification data associated to a user and a certificate of authentication certifying that the user has been authenticated by an authentication entity. The instructions 430 further cause the processor to: validate the first transaction request and generate a secure ledger entry on the basis of the validation.

In some cases, the instructions 430 cause the processor to determine whether the user was previously authorized to access the secure ledger. In some examples, the instructions 430 further cause the processor 410 to communicate a user activation request to the user, generate a second secure ledger entry comprising data indicating that the user activation request has been communicated to the user, receive a second secure ledger transaction request in response to the user activation request, validate the second transaction request and generate a third secure ledger entry based on the second transaction request wherein the third secure ledger entry indicates that the user is authorized to access the secure ledger.

Such machine-readable instructions may also be loaded onto a computer or other programmable data processing devices, so that the computer or other programmable data processing devices perform a series of operations to produce computer-implemented processing, thus the instructions executed on the computer or other programmable devices provide an operation for realizing functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the present disclosure. In particular, a feature or block from one example may be combined with or substituted by a feature/block of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1-13. (canceled)

14. A non-transitory computer readable medium encoded with instructions which when executed by a processor, cause the processor to:
receive a certificate of authentication from an authentication entity, the certificate of authentication certifying that a user has been authenticated by the authentication entity;
verify the certificate of authentication;
receive a cryptographic key associated to the user;
generate a secure ledger transaction request, the transaction request comprising the cryptographic key, identification data associated to the user and the certificate of authentication; and
communicate the transaction request to the secure ledger.

15. The computer readable medium of claim 14, wherein the certificate of authentication comprises
identification data associated to the user;
data comprising a request to authorize the user to access the secure ledger;
a cryptographically secure signature associated to the authentication entity; and
data comprising a time stamp and/or a time period in which the certificate of authentication is valid.

16. A non-transitory computer readable medium encoded with instructions which when executed by a processor cause the processor to:
receive a first secure ledger transaction request, the first transaction request comprising a cryptographic key associated to a user, identification data associated to a user and a certificate of authentication certifying that the user has been authenticated by an authentication entity;
validate the first transaction request; and
generate a secure ledger entry on the basis of the validation.

17. The computer readable medium of claim 16, wherein the instructions cause the processor to determine whether the user was previously authorized to access the secure ledger.

18. The computer readable medium of claim 16, wherein the instructions cause the processor to:
communicate a user activation request to the user;
generate a second secure ledger entry comprising data indicating that the user activation request has been communicated to the user;
receive a second secure ledger transaction request in response to the user activation request;
validate the second transaction request; and
generate a third secure ledger entry based on the second transaction request, the third secure ledger entry indicating that the user is authorized to access the secure ledger.

19. The computer readable medium of claim 18, wherein the user activation request comprises a nonce.

20. The computer readable medium of claim 19, wherein the instructions cause the processor to determine whether the second transaction request comprises the nonce.

21. A computing system comprising a processor and memory, the memory to store instructions that when executed by the processor cause the processor to:
access a certificate of authentication, the certificate of authentication certifying that a user has been authenticated by an authentication entity;
validate the certificate of authentication;
access a cryptographic key associated to the user;
generate a blockchain transaction request, the transaction request comprising the cryptographic key, identification data associated to the user and the certificate of authentication; and
transmit the transaction request to a blockchain entity.

22. The computing system of claim 21, wherein the certificate of authentication comprises:
user identification information;
a request to authorize the user to access the blockchain; and
a cryptographic data associated to the authentication entity.

23. The computing system of claim 22, wherein the cryptographic data comprises a cryptographically secure signature generated by the authentication entity.

24. A method for authorizing a user to access a secure ledger, the method comprising:
accessing a certificate of authentication, the certificate of authentication attesting that the user is authenticated;
validating the certificate of authentication;
receiving a cryptographic key from the user;
generating a secure ledger transaction request comprising the cryptographic key, identification data associated to the user and the certificate of authentication; and
transmitting the transaction request to the secure ledger.

25. The method of claim 24, comprising:
receiving a first secure ledger transaction request;
verifying the first transaction request; and
generating a secure ledger entry on the basis of the verification.

26. The method of claim 25, comprising:
transmitting a user activation request to the user;
generating a second secure ledger entry comprising data indicating that the user activation request has been transmitted to the user;
receiving a second secure ledger transaction request in response to the user activation request;
verifying the second transaction request; and
generating a third secure ledger entry based on the second transaction request, the third secure ledger entry indicating that the user is authorized to access the secure ledger.
